(19) United States
(12) Patent Application Publication
(10) Pub. No.: US 2007/0147594 A1
(43) Pub. Date: Jun. 28, 2007

(54) Methods, systems, and computer program products for billing for trust-based services provided in a communication network

(76) Inventors: Jeffrey Aaron, Atlanta, GA (US); Edgar Shrum JR., Smyrna, GA (US)

Correspondence Address: MYERS BIGEL SIBLEY & SAJOVEC, P.A., P.O. BOX 37428, RALEIGH, NC, 27627, US

(21) Appl. No.: 11/315,673

(22) Filed: Dec. 22, 2005

(51) Int. Cl. H04M 15/00

(52) U.S. Cl. 379/114.28

(57) ABSTRACT

A trust evaluation may be obtained for a network element in a communication network. Based on this trust evaluation, one or more services may be invoked to address the risk that a potentially untrustworthy network element poses in the communication network. For example, if the network element is determined to be untrustworthy, then the communication network may be at risk for increased hacker activity, virus infection, traffic errors, and the like. Multiple cost categories may be defined and cost amounts assigned thereto based on the trust evaluation of the network element and the invocation(s) of the one or more services in response to the trust evaluation. A determination of whether to bill for these cost amounts and what entities to bill for the cost amounts may then be made.

### FIELD OF THE INVENTION

The present invention relates to communication networks and methods of operating the same, and, more particularly, to methods, systems, and computer program products for billing for services on communication networks.

### BACKGROUND OF THE INVENTION

In a communication network, one or more network elements may be modified in an undesirable fashion, which may result in these network elements being considered untrustworthy or perhaps even a security risk. Various services may be invoked or actions taken to address the untrustworthy element(s) so as to reduce the potential for harm resulting from such things as hacker activity, software viruses, and the like. Such protective services and actions may be done continuously, periodically, and/or in direct response to a particular concern or event. In some cases, some of these protective services and actions may be done in anticipation of or in recognition of the potential likelihood of occurrence of an event such as a network element becoming and being determined/considered to be untrustworthy. These protective services and/or actions, however, may cause additional costs to be incurred or to potentially be incurred.

### SUMMARY OF THE INVENTION

According to some embodiments of the present invention, services provided in a communication network may be billed by obtaining a trust evaluation for a network element in the communication network, obtaining an indication of whether a service has been invoked due to the anticipation of and/or the recognition of the potential occurrence of, or in response to, the trust evaluation for the network element, defining a plurality of cost categories, adjusting cost amounts in the respective cost categories based on the trust evaluation for the network element and/or the indication of whether the service has been invoked, and determining whether to bill for the cost amounts.

In other embodiments, the cost categories comprise a direct category, an indirect category, and a future category.

In still other embodiments, the service comprises a traffic mirroring service for the network element, a traffic monitoring service for the network element, a traffic examination service for traffic associated with the network element, a traffic blocking service for traffic associated with the network element, a traffic storage service for traffic associated with the network element, a traffic logging service for traffic associated with the network element, an endpoint resource selection service for traffic associated with the network element, a midpoint selection service for traffic associated with the network element, a tunneling service for traffic associated with the network element, and/or an application management service for the network element.

In still other embodiments, a plurality of thresholds associated with the plurality of cost categories are defined. Moreover, determining whether to bill for the cost amounts comprises comparing the cost amounts with the plurality of thresholds, respectively and assigning the cost amounts to at least one entity based on the comparison of the cost amounts with the plurality of thresholds.

In still other embodiments, a determination is made, based on the assigned cost amounts, of dollar amounts to be billed to the at least one entity.

In still other embodiments, determining the dollar amounts to be billed to the at least one entity comprises applying different rules for different respective cost categories to calculate dollar amounts from the assigned cost amounts, respectively.

In still other embodiments, determining the dollar amounts to be billed is performed periodically and/or in response to an event in the communication network.

In still other embodiments, assigning the cost amounts to the at least on entity comprises associating the at least one entity with the service and/or with the network element.

In still other embodiments, obtaining the trust evaluation and obtaining an indication of whether a service has been invoked are repeatedly performed. Furthermore, the obtained trust evaluations and the obtained indications of whether a service has been invoked over time are filtered so as to discard at least some of the obtained trust evaluations and/or the obtained indications that a service has been invoked.

In still other embodiments, adjusting the cost amounts comprises adjusting the cost amounts based on a history of the obtained trust evaluations and/or obtained indications that a service has been invoked. The defined plurality of thresholds are adjusted based on the history and the filtering of the obtained trust evaluations and the obtained indications of whether a service has been invoked so as to change a rate at which at least some of the obtained trust evaluations and/or the obtained indications that a service has been invoked are discarded is adjusted based on the history.

In still other embodiments, adjustments made to the cost amounts, plurality of thresholds, and filtering based on the history persist indefinitely.

In still other embodiments, adjustments made to the cost amounts, plurality of thresholds, and filtering based on the history are temporary.

In still other embodiments, an adaptation threshold is defined. A count of the obtained trust evaluations and/or the obtained indications of whether a service has been invoked during an adaptation window time frame is compared with the adaptation threshold. The cost amounts are adjusted based on the comparison of the count with the adaptation threshold. The defined plurality of thresholds is adjusted based on the comparison of the count with the adaptation threshold. The filtering of the obtained trust evaluations and the obtained indications of whether a service has been invoked so as to change a rate at which at least some of the obtained trust evaluations and/or the obtained indications that a service has been invoked are discarded are adjusted based on the comparison of the count with the adaptation threshold.

In still other embodiments, defining the adaptation threshold comprises defining a plurality of adaptation thresholds.

In still other embodiments, adjustments made to the cost amounts, plurality of thresholds, and filtering based on a comparison of the count with the plurality of adaptation thresholds persists for a first time if the count exceeds a first one of the plurality of thresholds.

In still other embodiments, adjustments made to the cost amounts, plurality of thresholds, and filtering based on a comparison of the count with the plurality of adaptation thresholds persists for a second time if the count exceeds a second one of the plurality of thresholds where the second time is longer than the first time.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Other features of the present invention will be more readily understood from the following detailed description of exemplary embodiments thereof when read in conjunction with the accompanying drawings, in which:

FIG. 1 is a block diagram that illustrates a communication network in accordance with some embodiments of the present invention; and

FIGS. 2-4 are flowcharts that illustrate operations for billing for trust-based services in accordance with some embodiments of the present invention.

### DETAILED DESCRIPTION OF EXEMPLARY EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described herein with reference to flowchart and/or block diagram illustrations of methods, systems, and computer program products in accordance with exemplary embodiments of the invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

In some embodiments of the present invention, one or more trust-controlled services may be invoked to respond to detection of one or more untrusted network elements in a communication network. These protective services and/or actions, however, may cause additional costs to be incurred or to potentially be incurred (e.g., incurred at a later time) in the communication network. For example, merely providing the ability to operationally control such protective services and/or actions may be costly. Also, a variety of kinds of additional security costs may be incurred when the purpose of the service(s) and/or actions taken is to increase security in the communication network. Security risk can spread via secondary infection and hacker activity, which may result in additional promulgation of costs both realized (incurred) and anticipated (likely to be incurred). These costs may be absorbed by the provider(s) of the protective service(s) and/or actions, a contracted partner, and/or other parties. The costs may also be directly applied to the customers and/or users of the service(s) or products offered by a provider.

In some embodiments of the present invention, a trust evaluation may be obtained for a network element in a communication network. Based on this trust evaluation, one or more services may be invoked to address the risk that a potentially untrustworthy network element poses in the communication network. For example, if the network element is determined to be untrustworthy, then the communication network may be at risk for increased hacker activity, virus infection, traffic errors, and the like. Thus, according to some embodiments of the present invention, a billing module may be configured to determine a bill based on the trust evaluation for the network element and/or the indication of whether the service has been invoked. In particular embodiments of the present invention, multiple cost categories may be defined and cost amounts assigned thereto based on the trust evaluation of the network element and the invocation(s) of the one or more services in response to the trust evaluation. A determination of whether to bill for these cost amounts and what entities to bill for the cost amounts may then be made.

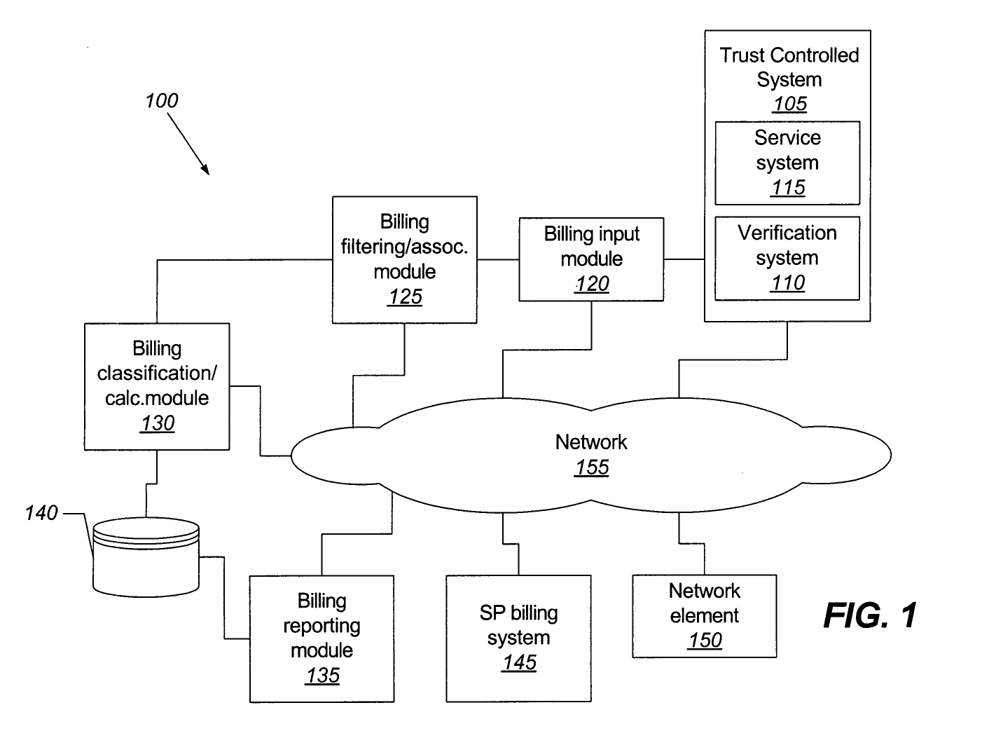

Referring now to FIG. 1, an exemplary network architecture 100 for billing for trust-based services, in accordance with some embodiments of the present invention, comprises a trust-controlled system 105, a billing input module 120, a billing filtering and association module 125, a billing classification and calculation module 130, a billing reporting module 135, a billing database 140, a service provider billing system 145, a network element 150, and a communication network 155 that are connected as shown. The network 155 may represent a global network, such as the Internet, and/or other publicly accessible network. The network 155 may also, however, represent a wide area network, a local area network, an Intranet, and/or other private network, which may not accessible by the general public. Furthermore, the network 155 may represent a combination of public and private networks or a virtual private network (VPN).

The trust-controlled system 105 may comprise two subsystems: a verification system 110 and a trust-controlled service system 115. The verification system 110 may be configured to determine whether the network element 150 is trustable or not, by, for example, determining a degree of trust for the network element 150. This trust information may then be provided to the storing/logging controller 115. The verification system 110 may be embodied as described in, for example, U. S. patent application Ser. No. 10/880,249 entitled “Verification of Consumer Equipment Connected to Packet Networks Based on Hashing Values” (hereinafter '249 application), and U. S. patent application Ser. No. 10/886,169 entitled “Controlling Quality of Service and Access in a Packet Network Based on Levels of Trust for Consumer Equipment” (hereinafter '169 application), the disclosures of which are hereby incorporated herein by reference in their entireties.

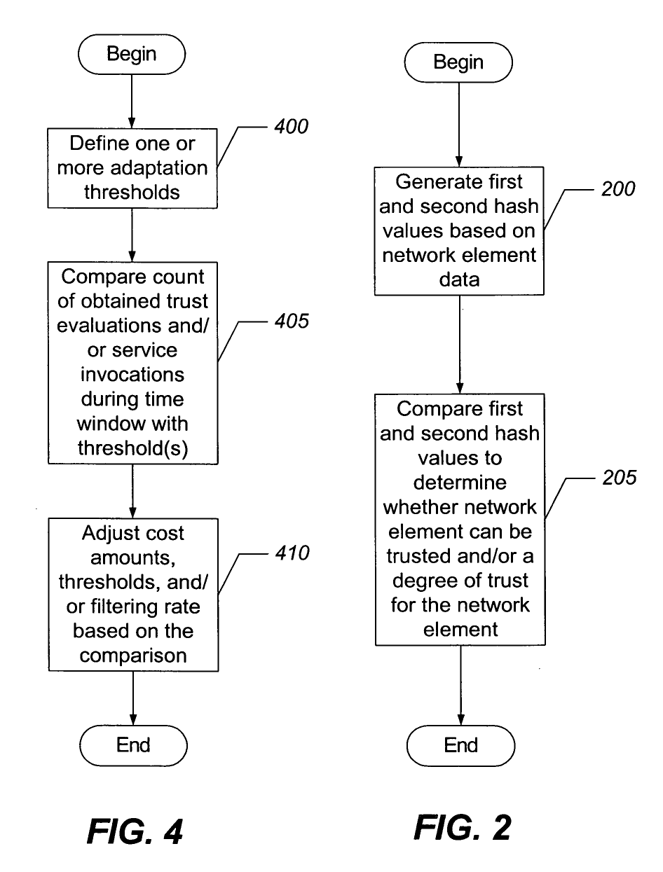

Referring to FIG. 2, as described in the '249 application and '169 application, the verification system 110 can determine a level of trust for the network element 150 by generating first and second hash values based on data that is associated with the network element 150 at block 200. This data may represent any type of software and/or firmware, for example, associated with the network element 150. If the hash values are not identical as determined by a comparison made at block 205, then an evaluation may be made to determine whether the network element 150 can be trusted and/or what degree of trust may be assigned to the network element 150 based on the apparent modification of the data as indicated by the non-identical hash values. Hashing of the data may include repetitively hashing nested portions of the data to generate a plurality of hash values. Nested hashing may be used, for example, to identify what portion of the data has changed. This could be done by generating first and second hashes of a grouped or collected set of portion(s) of the data, and, if any change were noted via differences in the first and second hash values, then subsequent checks of subsets of that set could be likewise checked to determine the specific subset containing the change. Further subsets of that subset could then be checked, and so on until the specific portion containing the change is determined. In accordance with various embodiments of the present invention, other techniques of determining trust of a network element may also be used and/or additional inputs may be obtained that provide an indication of the trustworthiness of a network element.

Returning to FIG. 1, as used herein, the term “network element” includes any device that is configured to communicate traffic, such as packet traffic, using the communication network 150. Accordingly, the network element 150 may be, but is not limited to, a router, a gateway, a switching device, a cable modem, a digital subscriber line modem, a public switched telephone network modem, a wireless local area network modem, a wireless wide area network modem, a computer with a modem, a mobile terminal such as personal data assistant and/or cellular telephone with a modem. For network elements that communicate via the communication network 135 through a wireless interface, wireless protocols, such as, but not limited to, the following may be used: a cellular protocol (e.g., General Packet Radio System (GPRS), Enhanced Data Rates for Global Evolution (EDGE), Global System for Mobile Communications (GSM), code division multiple access (CDMA), wideband-CDMA, CDMA2000, and/or Universal Mobile Telecommunications System (UMTS)), a wireless local area network protocol (e.g., IEEE 802.11), a Bluetooth protocol, another RF communication protocol, and/or an optical communication protocol.

The trust-controlled service system 115 may be configured to obtain trust and/or degree of trust information for network element(s) 150 from the verification system 110. In some embodiments, trust-relevant information from additional sources could alternately or additionally be considered. Such additional trust-relevant sources may include, but are not limited to, various network management systems, policy-based control systems, monitoring systems, including intrusion detection/protection systems, security scanning systems, third party security notification systems, outsourced security consulting/management services/systems, and/or security relevant information aggregation systems. Based on this trust information, the trust-controlled service system 115 may be invoked to respond to, for example, the potential risk posed by the untrustworthiness of one or more network elements 150. In accordance with various embodiments of the present invention, the trust-controlled service system 115 may provide one or more of the following services: a traffic mirroring service for the network element, a traffic monitoring service for the network element, a traffic examination service for traffic associated with the network element, a traffic blocking service for traffic associated with the network element, a traffic storage service for traffic associated with the network element, a traffic logging service for traffic associated with the network element, an endpoint resource selection service for traffic associated with the network element, a midpoint selection service for traffic associated with the network element, a tunneling service for traffic associated with the network element, and/or an application management service for the network element.

A traffic mirroring service, for example, may determine what aspects of the traffic associated with the network element (e.g., headers, particular sessions, payloads, etc.) should be mirrored and to which entities the mirrored traffic should be directed (e.g., local authorities, FBI, Homeland Security, etc.) based on the level of trust for the network element. An exemplary traffic mirroring service is described, for example, in U.S. Patent Application No. ______ entitled “METHODS, COMMUNICATION NETWORKS, AND COMPUTER PROGRAM PRODUCTS FOR MIRRORING TRAFFIC ASSOCIATED WITH A NETWORK ELEMENT BASED ON WHETHER THE NETWORK ELEMENT CAN BE TRUSTED,” the disclosure of which is hereby incorporated herein by reference.

Traffic monitoring, examination, and/or blocking services, for example, may determine what aspects of traffic associated with a network element should be monitored, examined, and/or blocked and in what manner. Exemplary traffic monitoring, examination, and/or blocking services are described, for example, in U. S. Patent Application No. ______ entitled “METHODS, COMMUNICATION NETWORKS, AND COMPUTER PROGRAM PRODUCTS FOR MONITORING, EXAMINING, AND/OR BLOCKING TRAFFIC ASSOCIATED WITH A NETWORK ELEMENT BASED ON WHETHER THE NETWORK ELEMENT CAN BE TRUSTED,” the disclosure of which is hereby incorporated herein by reference.

Traffic storing and/or logging services, for example, may determine what aspects of the traffic associated with the network element (e.g., headers, particular sessions, payloads, etc.) should be stored and/or logged and the particular destinations where the traffic is to be stored and/or logged (e.g., destinations associated with local authorities, FBI, Homeland Security, etc.) based on the level of trust for the network element. Exemplary traffic storing and/or logging services are described, for example, in U.S. Patent Application No. ______ entitled “METHODS, COMMUNICATION NETWORKS, AND COMPUTER PROGRAM PRODUCTS FOR STORING AND/OR LOGGING TRAFFIC ASSOCIATED WITH A NETWORK ELEMENT BASED ON WHETHER THE NETWORK ELEMENT CAN BE TRUSTED,” the disclosure of which is hereby incorporated herein by reference.

Endpoint and/or midpoint resource selection services for traffic associated with a network element, for example, may allow an endpoint and/or a midpoint path resource to be selected for the traffic so as to force the traffic to a desired traffic endpoint and/or through a desired traffic midpoint such that an untrustworthy network element may be avoided. Exemplary endpoint and/or midpoint resource selection services are described, for example, in U.S. Patent Application No. ______ entitled “METHODS, COMMUNICATION NETWORKS, AND COMPUTER PROGRAM PRODUCTS FOR SELECTING AN ENDPOINT AND/OR A MIDPOINT PATH RESOURCE FOR TRAFFIC ASSOCIATED WITH A NETWORK ELEMENT BASED ON WHETHER THE NETWORK ELEMENT CAN BE TRUSTED,” the disclosure of which is hereby incorporated herein by reference.

A tunneling service for traffic associated with a network element, for example, may allow a secure tunnel to be configured to convey vulnerable communications through or past an untrustworthy network element. The tunnel may be configured with a degree of data protection that is proportional to the degree to which the network element cannot be trusted. In this way, vulnerable data may be protected from undesirable potential hacking. An exemplary tunneling service is described, for example, in U.S. Patent Application No. ______ entitled “METHODS, COMMUNICATION NETWORKS, AND COMPUTER PROGRAM PRODUCTS FOR CONFIGURING A COMMUNICATION TUNNEL FOR TRAFFIC BASED ON WHETHER A NETWORK ELEMENT CAN BE TRUSTED,” the disclosure of which is hereby incorporated herein by reference.

An application management service for a network element, for example, may determine whether a network element in a communication path can be trusted and/or to what degree the network element can be trusted. Based on this determination, a separate determination can be made to identify potential network elements that may be vulnerable to attack or degradation of service, for example, due to the presence of one or more untrustworthy elements. An application may be identified on a vulnerable network element for which a command may be sent to reduce the vulnerability of the network element. An exemplary application management service is described, for example, in U.S. Patent Application No. ______ entitled “METHODS, COMMUNICATION NETWORKS, AND COMPUTER PROGRAM PRODUCTS FOR MANAGING APPLICATION(S) ON A VULNERABLE NETWORK ELEMENT DUE TO AN UNTRUSTWORTHY NETWORK ELEMENT BY SENDING A COMMAND TO AN APPLICATION TO REDUCE THE VULNERABILITY OF THE NETWORK ELEMENT,” the disclosure of which is hereby incorporated herein by reference.

Returning to FIG. 1, the billing input. module 120 may obtain the trust evaluation(s) for one or more network elements 150 and indications of whether one or more services have been invoked and, optionally, the number of invocations, in response to the trust evaluations from the trust controlled system 105. The billing input module 120 may perform any necessary translations on this information and then provide the information to the billing filtering and association module.

As will be described in more detail below, the billing filtering and association module 125 may filter the input obtained from the billing input module such that some of the obtained trust evaluations and service invocation information is discarded at a chosen rate. The billing filtering and association module 125 may also associate one or more entities, e.g., billing entities with the trust controlled system 105 if, for example, the billing modules are operated by a different entity than the trust controlled system 105.

The billing classification and calculation module 130 may be configured to categorize the costs associated with an untrustworthy network element in the network 135 and/or the costs associated with invoking one or more services to respond to, for example, the potential risk posed by the untrustworthy network element. In particular embodiments of the present invention, the billing classification and calculation module 130 may use three cost categories: a direct cost category, an indirect cost category, and a future cost category. The direct cost category corresponds to costs that may be assignable to a specific event or action. The indirect cost category corresponds to costs that may be assignable generally, such as overhead costs that are not associated with a specific event or action. The future cost category corresponds to costs that are assignable to the future because of a possibility of future harm and/or expense. Insurance expense is an example of a cost that can be categorized as a future cost. The billing classification and calculation module 130 may associate thresholds with the cost categories, respectively, that can be used to determine when to begin the process of assigning those costs to specific entities and/or determining how much of the costs should ultimately be billed to the various entities. The billing classification and calculation module 130 may further include rules and/or logic for comparing the cost amounts in the various categories with one or more thresholds defined for those categories to make the determinations with respect to assigning costs to entities and/or determining amounts of those costs to bill to the entities.

The billing reporting module 135 may be configured to obtain billing results from the billing classification and calculation module 130 and report them to another entity's billing or accounting system, such as the service provider billing system 145. The billing classification and calculation module 130 and billing reporting module 135 may share the database 140 for storing billing data and other information. For example, the database 140 may include data that associates network elements 150 in the network 155 with billing entities or customers and/or associates services invoked, for example through one or more trust controlled systems 105 with service provider entities. Identifications may be assigned to the entities associated with the various network elements, e.g., customers, and the service provider entities to allow indexing of cost/billing information in a database, for example.

Although FIG. 1 illustrates an exemplary communication network, it will be understood that the present invention is not limited to such configurations, but is intended to encompass any configuration capable of carrying out the operations described herein.

The trust controlled system 105, billing input module 120, billing filtering/association module 125, billing classification/calculation module 130, billing reporting module 135, and/or service provider billing system 145 may be embodied as one or more data processing systems that comprise, for example, input device(s), such as a keyboard or keypad, a display, and a memory that communicate with a processor. Such data processing system(s) may further include a storage system, a speaker, and an input/output (I/O) data port(s) that also communicate with the processor. The storage system may include removable and/or fixed media, such as floppy disks, ZIP drives, hard disks, or the like, as well as virtual storage, such as a RAMDISK. The I/O data port(s) may be used to transfer information between the data processing system(s) and another computer system or a network (e.g., the Internet). These components may be conventional components such as those used in many conventional computing devices, which may be configured to operate as described herein. Moreover, the functionality of the trust controlled system 105, billing input module 120, billing filtering/association module 125, billing classification/calculation module 130, and/or billing reporting module 135 may be implemented as a single processor system, a multi-processor system, or even a network of stand-alone computer systems, in accordance with various embodiments of the present invention.

Computer program code for carrying out operations of the trust controlled system 105, billing input module 120, billing filtering/association module 125, billing classification/calculation module 130, and/or billing reporting module 135 may be written in a high-level programming language, such as C or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

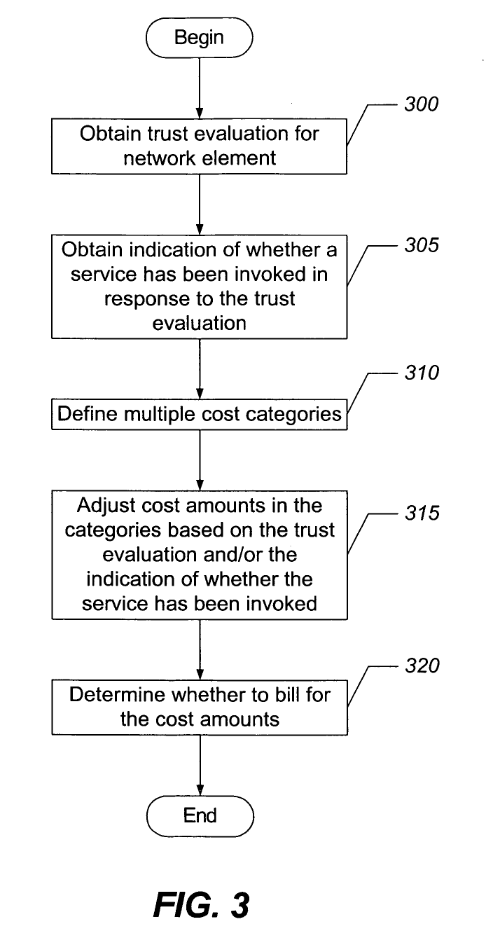

Exemplary operations for billing for trust-based services, in accordance with some embodiments of the present invention, will now be described with reference to FIGS. 3, 4, and 1. Referring to FIG. 3, in accordance with some embodiments of the present invention, operations begin at block 300 where the billing filtering/association module 125 obtains the trust evaluation for a network element from the trust controlled system 105 via the billing input module 120. Similarly, the billing filtering/association module 125 obtains an indication from the trust-controlled system 105 of whether a service has been invoked in response to the trust evaluation at block 305. This information is passed to the billing classification/calculation module 130 where multiple cost categories are defined for the costs associated with an untrustworthy network element 150 and responding to the untrustworthy network element 150 via invocation of one or more services at block 310. As discussed above, these cost categories may include, for example, but are not limited to a direct category, an indirect category, and/or a future category.

At block 315, the billing classification/calculation module adjusts the cost amounts in the categories based on the trust evaluation of the network element and/or indication(s) that one or more services have been invoked. The billing classification/calculation module 130 may then determine whether to bill one or more entities for the cost amounts accumulated in the various categories at block 320. Determining the dollar amounts to be billed may be performed periodically, e.g., on a regular billing cycle, and/or in response to an event, such as an event in the communication network 135.

As discussed above, one or more thresholds may be associated with the various cost categories that can be used in determining when to assign the cost amounts to one or more entities. In particular embodiments, the cost total in a cost category may be compared to a threshold to determine whether to assign that cost to one or more entities and, ultimately, whether to bill the cost to the one or more entities. For example, if there are minimal costs in a particular cost category such that the total does not exceed a particular threshold, then it may be desirable from a business standpoint to ignore those costs rather than pass them on to a customer or service provider. Once the costs in a category exceed the defined threshold, then there may be a business justification to pass those costs on to a service provider and/or customer. In accordance with various embodiments of the present invention, decisions for whether to allocate costs to one or more entities and to bill those costs to the one or more entities may be made on a category-by-category basis or multiple categories may be considered together and the costs allocated/billed only if a group total exceeds a particular threshold.

A business may also choose to not bill all of the costs accumulated in one or more categories to the particular entities responsible or may choose to add a surcharge to the costs when generating bill(s) for the responsible entities. Thus, rules may be applied to adjust the costs appropriately in calculating dollar amounts for bills based on the costs that have accumulated in the various categories. In accordance with various embodiments of the present invention, different rules may be used for different cost categories or the same rules may be applied to all of the cost categories in generating bills based on the accumulated costs.

In further embodiments of the present invention, trust-controlled billing systems and methods may adapt over time based, for example, on history or information obtained during adaptation time windows. For example, if historical data have shown that cost allocated and bills generated therefrom have been too high based on a particular trustworthiness obtained for a network element and/or particular services that are invoked for responding to the untrustworthiness of one or more network elements, then adjustments may be made in the way that the billing input module 120 filters the trust evaluations and/or service invocation information provided by the trust controlled system 105. For example, the filtering rate may be increased so that more of the information provided by the trust-controlled system is discarded to reduce the cost totals that are accumulated by the billing classification/calculation module 130. In addition to adjusting the filtering rate, the thresholds associated with the cost categories and used by the billing classification/calculation module 130 may be adjusted and/or the costs may be adjusted based on the historical data. In accordance with various embodiments of the present invention, the cost totals may be adjusted and/or the incremental amounts used in accumulating the cost totals may be adjusted.

The adjustments made to the filtering rate, thresholds, and/or costs based on historical information may be configured to persist indefinitely or, in some embodiments, may be configured to expire after a period of time has elapsed. For example, if the historical conditions that triggered the adjustments are not expected to last indefinitely, then it may be desirable for the adjustments to expire so that the billing system can return to a default configuration, for example.

Referring now to FIG. 4, particular embodiments of the present invention illustrating adaptation aspects for trust-controlled billing systems and methods will be described. Operations begin at block 400 where the billing classification/calculation module 130 defines one or more adaptation thresholds. At block 405, a count of the obtained trust evaluations and/or service invocations during an adaptation time window is compared with the one or more adaptation thresholds. At block 410, the thresholds associated with the cost categories, cost amounts, and/or filtering rate may be adjusted based on the comparison at block 405 similar to the way the adjustments are made based on historical information discussed above. Note that in some implementations, “count” as used herein may include associated trust evaluation results, such as degree-of-trust information in addition to a simple numerical count of trust evaluation and/or invocation occurrences.

By using multiple adaptation thresholds for “tuning” the billing system, more granularity may be achieved with respect to the persistence of the adjustments made to the filtering rate, cost amounts, and/or thresholds. For example, if the count of the obtained trust evaluations and/or service invocations during an adaptation time window exceeds a first threshold, then the adjustments made to the filtering rate, cost amounts, and/or thresholds may last for a relatively short time. If, however, the count exceeds a second threshold, then the adjustments may last for a longer time. Finally, if the count exceeds a third threshold, then the adjustments may persist indefinitely.

The flowcharts of FIGS. 2-4 illustrate the architecture, functionality, and operations of some embodiments of methods, billing systems, and computer program products for billing for trust-based services. In this regard, each block represents a module, segment, or portion of code, which comprises one or more executable instructions for implementing the specified logical function(s). It should also be noted that in other implementations, the function(s) noted in the blocks may occur out of the order noted in FIGS. 2-4. For example, two blocks shown in succession may, in fact, be executed substantially concurrently or the blocks may sometimes be executed in the reverse order, depending on the functionality involved.

Some embodiments of the present invention may be illustrated by way of example. Some time in the past, the trust-controlled system 105 checks the configuration of all of Monica's home network PCs including the laptop used by Monica's daughter Torrie such that initial acceptable hash results are recorded. Periodically, the trust-controlled system 105 re-checks the PCs, including Torrie's laptop.

Monica is an avid gamer and has recently signed up for a bundle of security enhancing trust-controlled services provided through the trust-controlled system 105 and has installed the associated client software on all of her PCs including Torrie's laptop. At her school, Torrie initiates a WiFi connection to access calendar files on her mother's PC. The trust-controlled system 105 determines that Torrie's laptop now has a somewhat lower trust level than before, but not low enough for access to be blocked. The trust-controlled system 105 signals Monica's residential gateway to initiate active monitoring of the connection to look for hacker activity.

Another trust-controlled system 105 determines that one of the routers in the WiFi network has become untrusted and informs Torrie's laptop. Torrie's client software requests and obtains a secure tunnel through the suspicious router so that her connection and data cannot be tampered with or tapped.

The monitoring and secure tunnel services are reported to Monica's network providers billing server, which classifies their costs, assigns a direct charge for the monitoring to Monica's monthly bill, and assigns another direct charge to the WiFi provider.

As further indications are obtained from the trust-controlled system 105 that Torrie's laptop was infected by a worm from the WiFi network based on history information, the main network provider assigns future costs to pay for security risk insurance to cover the added risk apparently associated with the WiFi provider, i.e., to cover future expenses that may arise. In this way, the main network provider protects itself financially from the WiFi provider's lack of security.

Likewise, the security risk added by Monica subscribing to on-line gaming services, which can cause her gaming PC to become untrusted, are detected and indirect and future insurance costs are assigned to her bill at a rate partly dependent on her history and that of other customers in similar conditions.

Many variations and modifications can be made to the embodiments described herein without substantially departing from the principles of the present invention. All such variations and modifications are intended to be included herein within the scope of the present invention, as set forth in the following claims.

That which is claimed:

1. A method of billing for services provided in a communication network, comprising:
obtaining a trust evaluation for a network element in the communication network;
obtaining an indication of whether a service has been invoked in response to, or due to a general anticipation or recognition of the potential occurrence of, the trust evaluation for the network element;
defining a plurality of cost categories;
adjusting cost amounts in the respective cost categories based on the trust evaluation for the network element and/or the indication of whether the service has been invoked; and
determining whether to bill for the cost amounts.

2. The method of claim 1, wherein the cost categories comprise a direct category, an indirect category, and a future category.

3. The method of claim 1, wherein the service comprises a traffic mirroring service for the network element, a traffic monitoring service for the network element, a traffic examination service for traffic associated with the network element, a traffic blocking service for traffic associated with the network element, a traffic storage service for traffic associated with the network element, a traffic logging service for traffic associated with the network element, an endpoint resource selection service for traffic associated with the network element, a midpoint selection service for traffic associated with the network element, a tunneling service for traffic associated with the network element, and/or an application management service for the network element.

4. The method of claim 1, further comprising:
defining a plurality of thresholds associated with the plurality of cost categories; and
wherein determining whether to bill for the cost amounts comprises:
comparing the cost amounts with the plurality of thresholds, respectively;
assigning the cost amounts to at least one entity based on the comparison of the cost amounts with the plurality of thresholds.

5. The method of claim 4, further comprising:
determining, based on the assigned cost amounts, dollar amounts to be billed to the at least one entity.

6. The method of claim 5, wherein determining the dollar amounts to be billed to the at least one entity comprises:
applying different rules for different respective cost categories to calculate dollar amounts from the assigned cost amounts, respectively.

7. The method of claim 5, wherein determining the dollar amounts to be billed is performed periodically and/or in response to an event in the communication network.

8. The method of claim 5, wherein assigning the cost amounts to the at least on entity comprises:
associating the at least one entity with the service and/or with the network element.

9. The method of claim 5, wherein obtaining the trust evaluation and obtaining an indication of whether a service has been invoked are repeatedly performed;
wherein the method further comprises:
filtering the obtained trust evaluations and the obtained indications of whether a service has been invoked over time so as to discard at least some of the obtained trust evaluations and/or the obtained indications that a service has been invoked.

10. The method of claim 9, wherein adjusting the cost amounts comprises adjusting the cost amounts based on a history of the obtained trust evaluations and/or obtained indications that a service has been invoked;
wherein the method further comprises:
adjusting the defined plurality of thresholds based on the history; and
adjusting the filtering of the obtained trust evaluations and the obtained indications of whether a service has been invoked so as to change a rate at which at least some of the obtained trust evaluations and/or the obtained indications that a service has been invoked are discarded based on the history.

11. The method of claim 10, wherein adjustments made to the cost amounts, plurality of thresholds, and filtering based on the history persist indefinitely.

12. The method of claim 10, wherein adjustments made to the cost amounts, plurality of thresholds, and filtering based on the history are temporary.

13. The method of claim 9, further comprising:
defining an adaptation threshold;
comparing a count of the obtained trust evaluations and/or the obtained indications of whether a service has been invoked during an adaptation window time frame with the adaptation threshold;
adjusting the cost amounts based on the comparison of the count with the adaptation threshold;
adjusting the defined plurality of thresholds based on the comparison of the count with the adaptation threshold; and
adjusting the filtering of the obtained trust evaluations and the obtained indications of whether a service has been invoked so as to change a rate at which at least some of the obtained trust evaluations and/or the obtained indications that a service has been invoked are discarded based on the comparison of the count with the adaptation threshold.

14. The method of claim 9, wherein defining the adaptation threshold comprises defining a plurality of adaptation thresholds.

15. The method of claim 15, wherein adjustments made to the cost amounts, plurality of thresholds, and filtering based on a comparison of the count with the plurality of adaptation thresholds persists for a first time if the count exceeds a first one of the plurality of thresholds.

16. The method of claim 15, wherein adjustments made to the cost amounts, plurality of thresholds, and filtering based on a comparison of the count with the plurality of adaptation thresholds persists for a second time if the count exceeds a second one of the plurality of thresholds where the second time is longer than the first time.

17. A computer program product for billing for services provided in a communication network, comprising:
a computer readable storage medium having computer readable program code embodied therein, the computer readable program code being configured to carry out the method of claim 1.

18. A billing system for billing for services provided in a communication network, comprising:
a trust controlled system that is configured to provide a trust evaluation for a network element in the communication network and an indication of whether a service has been invoked in response to, or due to a general anticipation or recognition of the potential occurrence of, the trust evaluation for the network element; and
a billing module that is configured to determine a bill based on the trust evaluation for the network element and/or the indication of whether the service has been invoked.

19. The billing system of claim 18, wherein the billing module is further configured to adjust cost amounts in respective ones of a plurality of cost categories based on the trust evaluation for the network element and/or the indication of whether the service has been invoked, wherein the cost categories comprise a direct category, an indirect category, and a future category.

20. The billing system of claim 18, wherein the service comprises a traffic mirroring service for the network element, a traffic monitoring service for the network element, a traffic examination service for traffic associated with the network element, a traffic blocking service for traffic associated with the network element, a traffic storage service for traffic associated with the network element, a traffic logging service for traffic associated with the network element, an endpoint resource selection service for traffic associated with the network element, a midpoint selection service for traffic associated with the network element, a tunneling service for traffic associated with the network element, an application management service for the network element.
